(19) United States
(12) Patent Application Publication
(10) Pub. No.: US 2011/0307359 A1
(43) Pub. Date: Dec. 15, 2011

(54) SYSTEMS AND METHODS FOR MANAGING ADDRESS AND TAX INVENTORY DATA

(75) Inventors: Ramakrishna Gude, Tampa, FL (US); Rose Joy, Chennai (IN)

(73) Assignee: VERIZON PATENT AND LICENSING, INC., Basking Ridge, NJ (US)

(21) Appl. No.: 12/797,771

(22) Filed: Jun. 10, 2010

(51) Int. Cl. G06Q 10/00; G06F 11/07; G06Q 40/00

(52) U.S. Cl. 705/31; 714/2; 714/48; 714/E11.023; 714/E11.024

(57) ABSTRACT

An exemplary method includes a computing system accessing inventory data maintained in a repository of inventory data, the inventory data maintained for use in determining tax revenue to be collected from at least one customer, and auditing the inventory data, the audit including accessing a data record included in the inventory data, subjecting the data record to at least one of a validation process, a range split condition check process, and a tax code identifier check process, and generating output data representative of a result produced by the at least one of the validation process, the range split condition check process, and the tax code identifier check process. When the result indicates an error condition, the output data is configured to facilitate a correction of the error condition in the inventory data included in the repository of inventory data. Corresponding methods and systems are also disclosed.

### BACKGROUND INFORMATION

Government entities often levy taxes and/or fees (collectively “taxes”) on sales of products and/or services. Accordingly, certain providers of products and/or services have to collect tax revenues associated with the sales of products and/or services and remit the collected tax revenues to one or more government entities. This can be a difficult task for providers that provide products and/or services over a geographic area that spans numerous government entities having different tax regulations.

For example, a service provider that provides mobile phone or television services to subscribers over a large geographic area typically has to ensure that the correct tax revenues are collected from each subscriber. Given the differences in taxes levied by various government entities, as well as the ever-changing nature of government tax regulations, the service provider typically has to expend significant resources to track applicable tax regulations mandated by myriad government entities in order to collect tax revenues in compliance with current, applicable tax regulations. If the service provider collects tax revenues from a subscriber incorrectly (e.g., in accordance with the wrong tax regulations), the service provider may be required to pay a penalty to one or more government entities.

To assist with the collection of appropriate tax revenues, providers of products and/or services have employed conventional tools designed to match applicable tax regulations to subscribers based on the physical addresses associated with the subscribers (e.g., subscriber billing addresses). Unfortunately, such conventional tools have shortcomings. For example, it is not uncommon for such conventional tools to produce inaccurate results, to require significant resources (including burdensome amounts of manual input and/or computer memory and processing resources), to be inefficient, and/or to lack user-friendly interfaces and/or user-configurable options.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary system for managing address and tax inventory data according to principles described herein.

FIG. 2 illustrates exemplary components of an inventory data maintenance subsystem according to principles described herein.

FIG. 3 illustrates exemplary components of an inventory data management subsystem according to principles described herein.

FIG. 4 illustrates an exemplary implementation of inventory data.

FIG. 5 illustrates exemplary components of a tax code management subsystem according to principles described herein.

FIG. 6 illustrates an exemplary tax translation data table according to principles described herein.

FIG. 7 illustrates exemplary components of an address validation subsystem according to principles described herein.

FIG. 8 illustrates exemplary components of a geographic validation subsystem according to principles described herein.

FIG. 9 illustrates exemplary components of a spatial validation subsystem according to principles described herein.

FIG. 10 illustrates an exemplary method of managing address and tax inventory data according to principles described herein.

FIG. 11 illustrates an exemplary method of auditing inventory data according to principles described herein.

FIG. 12 illustrates an exemplary method of checking for an address range split condition according to principles described herein.

FIG. 13 illustrates an exemplary range of street addresses according to principles described herein.

FIG. 14 illustrates an exemplary computing device according to principles described herein.

### DETAILED DESCRIPTION OF PREFERRED EMBODIMENTS

Exemplary systems and methods for managing address and tax inventory data are described herein. As used herein, “address and tax inventory data,” “address inventory data,” “tax inventory data,” or simply “inventory data” may refer to electronic data that is maintained (e.g., in a database or other data repository) for use by a provider of a product or service to determine appropriate tax revenues (e.g., taxes, fees, and/or other charges levied by one or more governmental entities) to be collected from one or more customers based on physical addresses associated with the customers. Inventory data may include any data that is potentially helpful for this purpose, including, but not limited to, data representative of street address information (e.g., street identifiers such as street names, unit identifiers such as suite numbers, city identifiers, state identifiers, county identifiers, zip codes, postal codes), ranges of street addresses (e.g., ranges of street numbers), range type identifiers indicating types of street address ranges, and tax code information indicating one or more tax code identifiers (or simply “tax codes”) to be used by the provider to determine appropriate tax revenues to be collected.

In order to help keep inventory data current with ever-changing and/or diverse tax regulations set forth by one or more government entities, the systems and methods described herein provide for auditing and facilitating updating of inventory data based on the audit. The systems and methods may provide one or more improvements in efficiency, accuracy, resource management, scalability, and/or user manageability as compared to conventional tools. For example, the systems and/or methods may facilitate a reduction in manual labor requirements, a reduction in resources required to audit data records, an improvement in accuracy of audit results (e.g., accuracy of street address range splits), and/or an improvement in automation of error reporting and/or error correction processes as compared to conventional tools.

Exemplary systems and methods for managing address and tax inventory data, including exemplary processes for auditing the inventory data will now be described with reference to the drawings.

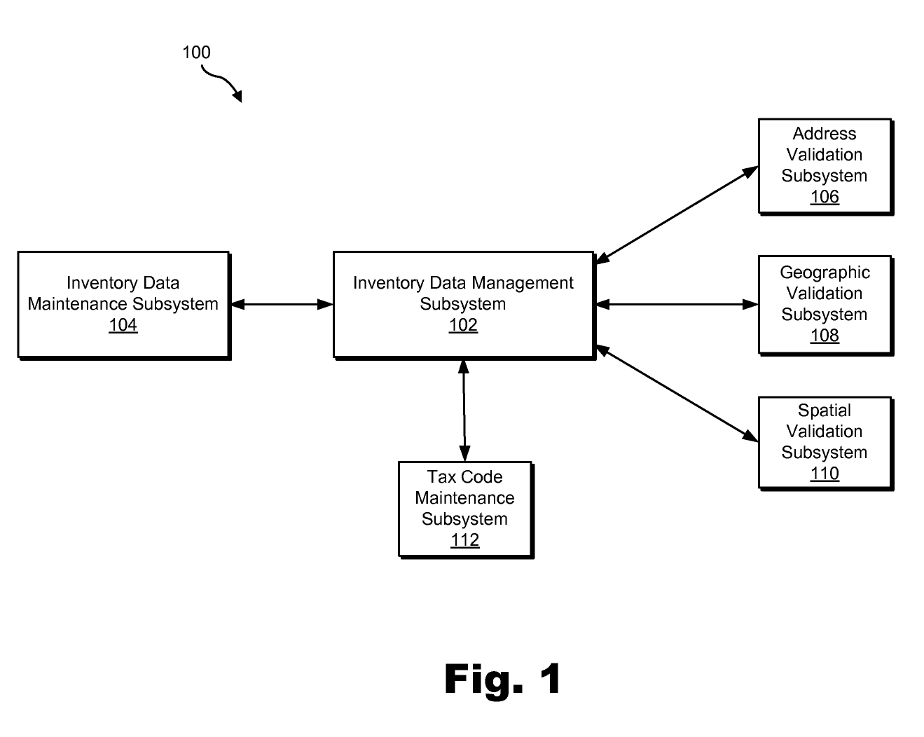

FIG. 1 illustrates an exemplary address and tax inventory data management system 100 (or simply “system 100”). System 100 may include an inventory data management subsystem 102 (or simply “management subsystem 102”) communicatively coupled to an inventory data maintenance subsystem 104 (or simply “maintenance subsystem 104”), an address validation subsystem 106, a geographic validation subsystem 108, a spatial validation subsystem 110, and a tax code maintenance subsystem 112. Subsystems 102-112 may communicate one with another using any suitable communication technologies.

Maintenance subsystem 104, which may be operated by a provider of a product or service, may be configured to maintain inventory data in a repository of inventory data for use by the provider in determining tax revenues to be collected from at least one customer. In some examples, the inventory data in the repository may be used by one or more departmental systems of the provider (e.g., billing, order fulfillment, marketing, or other departmental systems within a provider enterprise) to determine appropriate tax revenues to be collected from one or more customers. As an example, inventory data maintained by maintenance subsystem 104 may include data records specifying ranges of street addresses and tax code identifiers associated with the ranges of street addresses, and a departmental system of a service provider, such as a billing system, may be able to access and utilize the inventory data to determine a tax code identifier associated with a particular range of street addresses. The billing system may associate the tax code identifier with one or more customer accounts of one or more customers who have physical addresses located within the range of street addresses and utilize the tax code identifier to bill appropriate taxes to the one or more customers.

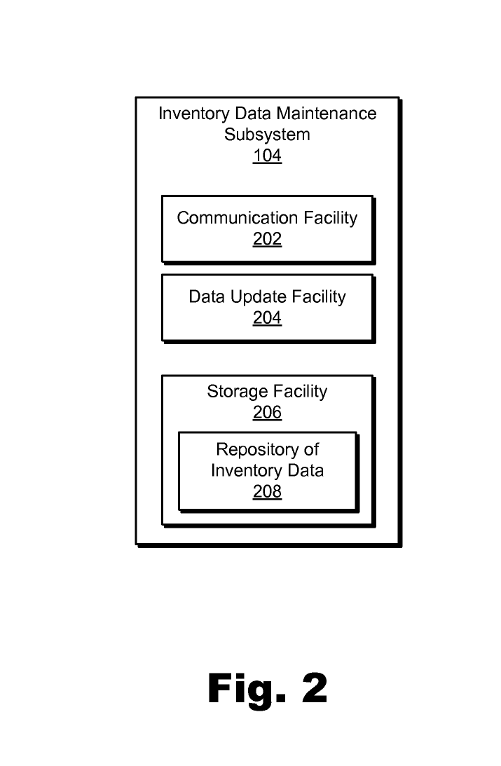

FIG. 2 illustrates exemplary components of maintenance subsystem 104. As shown, maintenance subsystem 104 may include a communication facility 202, a data update facility 204, and a storage facility 206 storing inventory data in a repository of inventory data 208. Facilities 202-206 may be in communication with one another using any suitable communication technologies.

Communication facility 202 may include any communication technologies suitable for communicating with management subsystem 102, as well as with one or more departmental systems of a provider (e.g., a marketing department system, a billing department system, etc.).

Data update facility 204 may be configured to update inventory data included in the repository of inventory data 208 stored in storage facility 206. As an example, communication facility 202 may receive an update message from management subsystem 102 and data update facility 204 may update the repository of inventory data 208 in accordance with the update message.

Storage facility 206 may be configured to store inventory data in the repository of inventory data 208. The inventory data may be organized and maintained in any suitable way, such as within one or more databases (e.g., one or more relational databases). In certain embodiments, the inventory data may include data records representative of ranges of street addresses, as well as address information, tax code identifiers, and range type indicators associated with the ranges of street addresses. It will be recognized that storage facility 206 may maintain additional or alternative data as may serve a particular implementation.

Management subsystem 102 may be configured to communicate with maintenance subsystem 104, including accessing inventory data included in the repository of inventory data 208 and/or directing maintenance subsystem 104 to update inventory data included in the repository of inventory data 208. For example, management subsystem 102 may access inventory data from maintenance subsystem 104, perform an audit of the inventory data, and generate output data representative of results of the audit as described herein. In certain examples, based on the results of the audit, management subsystem 102 may provide an update message to maintenance subsystem 104 that is configured to direct maintenance subsystem 104 to update the repository of inventory data 208. The update message may indicate when and/or how the repository of inventory data 208 is to be updated. For example, when a result of the audit indicates an error condition associated with the inventory data, output data representative of the error condition may be generated such that the output data is configured to facilitate a correction of the error condition in the repository of inventory data 208. Management subsystem 102 may generate an update message based on the output data and provide the update message to maintenance subsystem 104 to direct maintenance subsystem 104 to update inventory data to correct the error condition. As described in more detail further below, in certain embodiments, the error condition may include, without limitation, an address error, a geographic error, a spatial error, an attribute mismatch, and/or a tax code identifier mismatch associated with the inventory data.

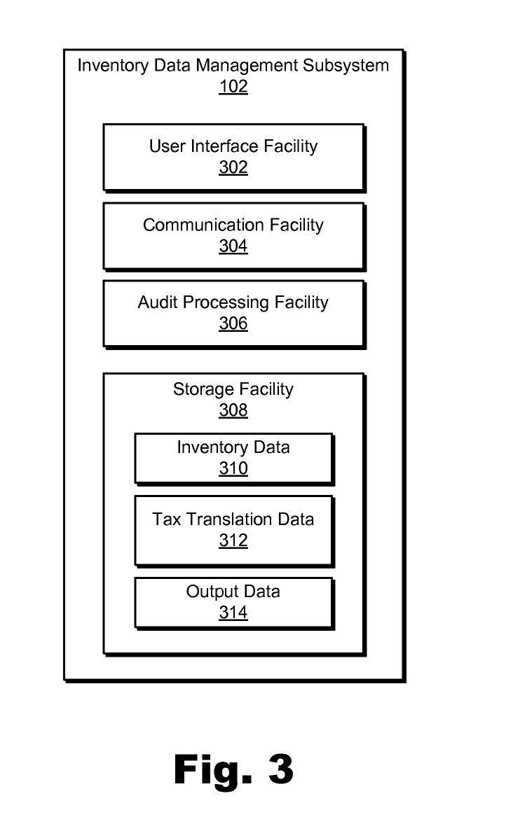

FIG. 3 illustrates exemplary components of management subsystem 102. As shown, management subsystem 102 may include a user interface facility 302, a communication facility 304, an audit processing facility 306, and a storage facility 308, which may be in communication with one another using any suitable communication technologies.

User interface facility 302 may be configured to provide a user interface for use by a user of management subsystem 102 to access functions, features, and/or data of management subsystem 102. For example, user interface facility 302 may provide one or more tools configured to allow a user to customize one or more audit parameters, such as batches to be audited (e.g., by specifying a wire center, zip code, or other area to be audited), a maximum size of a batch to be audited, a length of a segment to be used in an audit, an audit schedule, etc., for use by audit processing facility 306 in executing an audit of inventory data. As another example, user interface facility 302 may provide one or more tools configured to allow a user to access and review output data generated to represent a result of an audit of inventory data and/or to initiate one or more operations based on the output data. For instance, user interface facility 302 may present data representative of the output data in a user interface (e.g., a graphical user interface) for consideration by a user. The user may review the output data to double check an error condition reported by the audit and conveniently provide an input command to initiate execution of an operation to correct the error correction based on the output data. User interface facility 302 may receive the command input by the user, and in response to the command, management subsystem 102 may generate an update message based on the output data and provide the update message to maintenance subsystem 104 to direct maintenance subsystem 104 to update inventory data based on the output data in order to correct the error condition. As yet another example, user interface facility 302 to provide one or more tools configured to allow a user to access information about error data, error corrections, audit log data, audit reports, users of management subsystem 102, performance of management subsystem 102, and/or any statistic or report associated with a user of management subsystem 102 and/or an audit performed by management subsystem 102.

Communication facility 304 may employ any communication technologies suitable for communicating with subsystems 104-112. In certain embodiments, communication facility 304 may include one or more application program interfaces configured to enable management subsystem 102 to interact with subsystems 104-112, including accessing inventory data from and/or sending messages to maintenance subsystem 104.

Audit processing facility 306 may be configured to audit inventory data. An audit is generally configured to detect certain error conditions associated with the inventory data and to report the detected error conditions in a manner that may facilitate correction of the error conditions. Exemplary audit processing that may be performed by audit processing facility 306 is described in detail further below.

Storage facility 308 may be configured to store inventory data 310, tax translation data 312, and output data 314. Inventory data 310 may include any inventory data accessed by management subsystem 102 from the repository of inventory data 208 maintained by maintenance subsystem 104. For example, management subsystem 102 may request inventory data from management subsystem 104, and in response management subsystem 104 may generate and provide a copy of inventory data (e.g., an export file) to management subsystem 102, which may store the copy of inventory data in storage facility 308 as inventory data 310. Inventory data 310 may be accessed by audit processing facility 306 for use in auditing the inventory data 310.

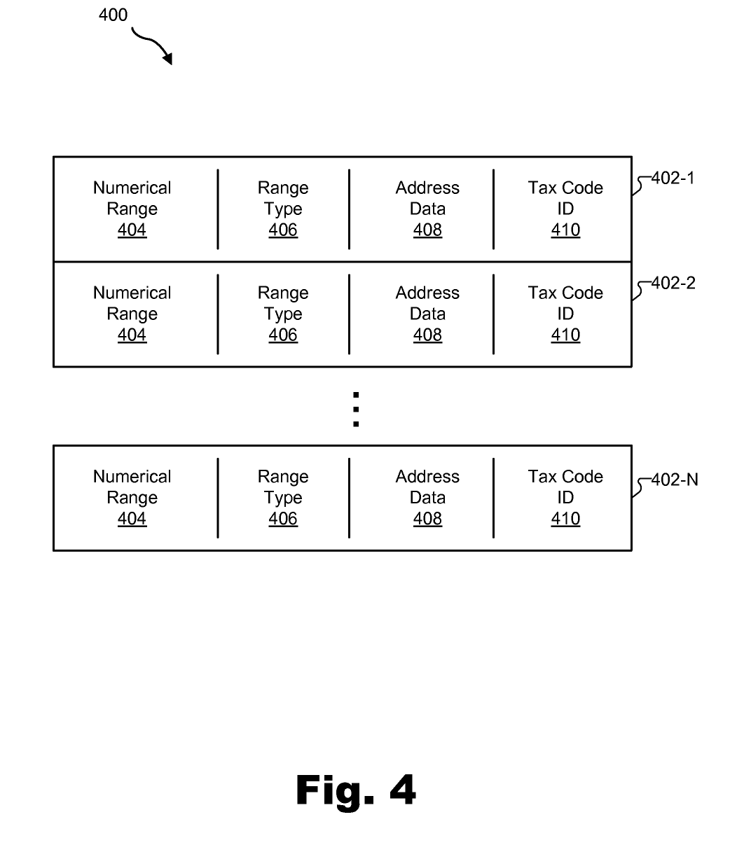

In certain embodiments, inventory data 310 may include one or more data records each representing a range of street addresses. Each data record may include data representative of the range of street addresses, address information associated with the range of street addresses, a range type indicator indicating a range type associated with the range of street addresses, and a tax code identifier associated with the range of street addresses. FIG. 4 illustrates an exemplary implementation 400 of inventory data 310. As shown, implementation 400 may include a plurality of data records 402 (e.g., data records 402-1 through 402-N). In implementation 400, each row in a data table represents a data record 402 having data representative of a numerical range of street addresses 404, a range type 406 associated with the range of street addresses 404, address data 408 associated with the range of street addresses 404, and a tax code identifier 410 (“tax code ID 410”) associated with the range of street addresses 404.

Returning to FIG. 3, tax translation data 312 may include data representative of mappings (i.e., translations) between tax code identifiers and sets of tax jurisdictional attributes. For example, tax translation data 312 may include a mapping of a particular set of tax jurisdictional attributes to a particular tax code identifier, which mapping is indicative of a relationship between the particular set of tax jurisdictional attributes and the particular tax code identifier. As used herein, a “tax jurisdictional attribute” or simply “attribute” may refer to any indicator of a tax jurisdiction or other tax-related characteristic, and a “tax code identifier” or “tax code” may refer to any indicator that may be used to determine appropriate tax revenues to be collected from one or more customers. To illustrate, a tax code identifier may be used by a departmental system of a service provider enterprise to determine how much tax revenue to collect from one or more customers. Because the tax code identifier is mapped to a set of tax jurisdictional attributes, the amount of tax to be collected, as determined from the tax code identifier, will be accurate for a customer having a physical address associated with the set of tax jurisdictional attributes mapped to the tax code identifier in the tax translation data 312. Examples of tax jurisdictional attributes are described in more detail further below.

Tax translation data 312 typically includes a copy of tax translation data maintained by tax code maintenance subsystem 112, which, in certain embodiments, may be operated by the same provider operating maintenance subsystem 104 and management subsystem 102. For instance, tax code maintenance subsystem 112 may include or be part of a tax departmental system of the provider enterprise.

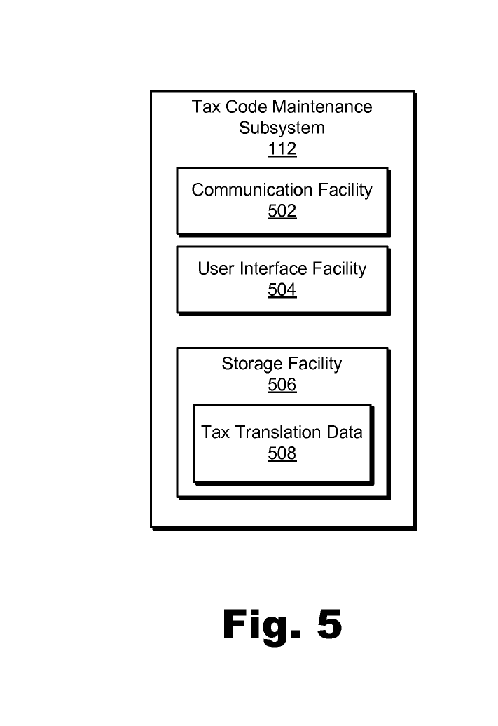

FIG. 5 shows exemplary components of tax code maintenance subsystem 112. As shown, tax code maintenance subsystem 112 may include a communication facility 502, a user interface facility 504, and a storage facility 506 storing tax translation data 508. Facilities 502-506 may be in communication with one another using any suitable communication technologies.

Communication facility 502 may include any communication technologies suitable for communicating with management subsystem 102. Accordingly, communication facility 502 may be configured to transmit data (e.g., a copy of tax code translational data 508) to management subsystem 102 and/or receive messages (e.g., tax translation data requests) from management subsystem 102. As described further below, in certain examples, management subsystem 102 may be configured to send a message to tax code maintenance subsystem 112 that is configured to facilitate updating of tax translation data 508 by tax code maintenance subsystem 112 and/or by a user of tax code maintenance subsystem 112.

User interface facility 504 may be configured to provide a user interface for use by a user of tax code maintenance subsystem 112 to access functions, features, and/or data of tax code maintenance subsystem 112. For example, user interface facility 504 may provide one or more tools configured to allow a user of tax code maintenance subsystem 112 to add, modify, and/or delete tax code identifiers, tax jurisdictional attributes, and/or mappings of tax code identifiers and sets of tax jurisdictional attributes. Accordingly, tax personnel of the service provider may keep tax code translational data current based on results of an audit executed by management subsystem 102. Examples of management subsystem 102 executing an audit and outputting a message to tax code maintenance subsystem 112 to facilitate updating of tax translation data 508 maintained by tax code maintenance subsystem 112 are described further below.

Tax translation data 508 may be organized and maintained in storage facility 506 in any suitable way, such as within one or more databases (e.g., one or more relational databases) and/or within one or more tables. As mentioned above, tax translation data 508 may include data records representative of mappings between tax code identifiers and sets of tax jurisdictional attributes. It will be recognized that storage facility 506 may maintain additional or alternative data as may serve a particular implementation.

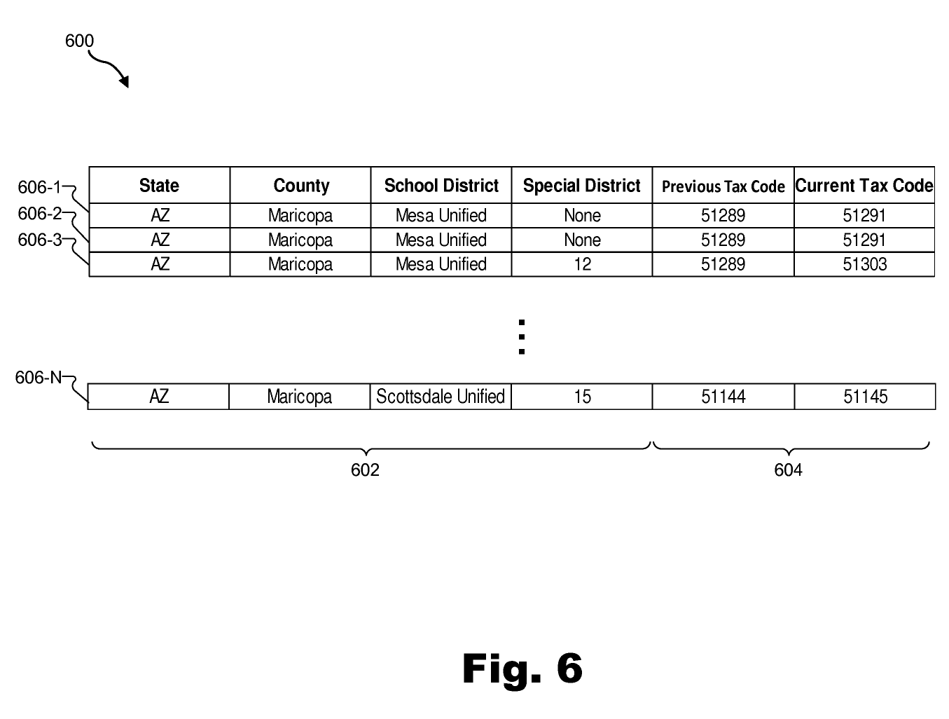

FIG. 6 illustrates an exemplary tax translation data table 600. As shown, tax translation data table 600 may include various sets of tax jurisdictional attributes 602 mapped to various tax code identifiers 604. Each row 606 (e.g., rows 606-1 through 606-N) in data table 600 may represent a mapping of a particular set of tax jurisdictional attributes 602 to a particular tax code identifier 604. For example, row 606-1 specifies a set of jurisdictional attributes for state, county, school district, and special district tax jurisdictions in which the particular set of tax jurisdictional attributes (e.g., “AZ,” “Maricopa,” “Mesa Unified,” and “None” in row 606-1) is mapped to a previous tax code (e.g., “51289” in row 606-1) and a current tax code (e.g., “51291” in row 606-1). The example illustrated in FIG. 6 is illustrative only. Typically, a tax translation data table represented by tax translation data 508 will be larger and more complicated than table 600. In addition, the tax jurisdictions and sets of tax jurisdictional attributes shown in FIG. 6 are illustrative only. Other tax jurisdictions and/or sets of tax jurisdictional attributes may be used in other examples.

Returning to FIG. 3, output data 314 may include data representative of results of one or more audits of inventory data 310 performed by audit processing facility 306. For example, output data may include log data related to execution of an audit, error data specifying one or more error conditions detected by an audit, and/or report data specifying results (e.g., performance and/or error statistics) of an audit.

Output data 314 may be configured to facilitate correction of one or more error conditions indicated in output data 314. For example, output data 314 may be configured to facilitate execution of one or more operations to correct one or more error conditions indicated in output data 314. To illustrate, user interface facility 302 may be configured to process output data 314 and to selectively insert data included in output data 314 in one or more user interfaces for consideration by a user. For instance, user interface facility 302 may be configured to search output data 314 to identify instances of a particular type of error condition and provide data representative of the error conditions of that particular error type in a user interface for consideration by a user of management subsystem 102. The user may review and/or analyze the error conditions and selectively initiate execution of one or more operations to correct the error conditions. For instance, when the user reviews and agrees that a reported error condition is accurate, the user may provide input through a user interface (e.g., by selecting a virtual button in the user interface) to initiate an operation configured to correct the reported error condition based on the output data. In response, management subsystem 102 may generate and send an update message to maintenance facility 104. As mentioned, the update message may be configured to direct maintenance facility 104 to update inventory data in the repository of inventory data 208 in a way that will correct the reported error condition.

As mentioned, management subsystem 102 may be configured to audit inventory data 310. As part of an execution of an audit process, in certain embodiments management subsystem 102 may communicate with subsystems 106-110, which may be configured to perform validation processes on the inventory data 310. To this end, subsystems 106-110 may access and/or maintain data that may be used to validate inventory data 310. In certain examples, the data may be periodically received or otherwise accessed by subsystems 106-110 through a service provided by a third party (i.e., an entity other than the service provider and the customers of the service provider). Each of the subsystems 106-110 will now be described in additional detail.

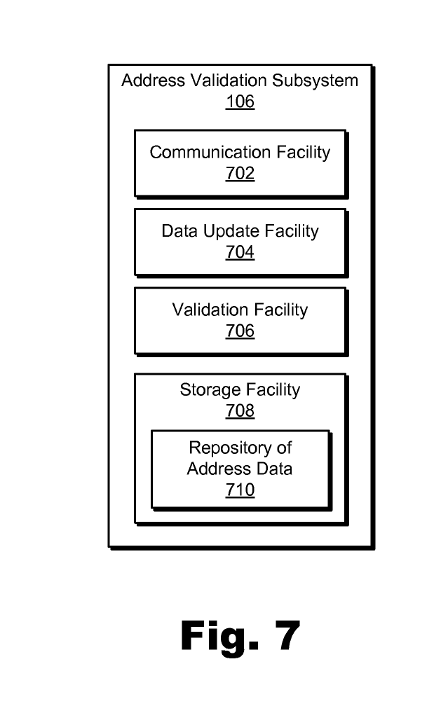

FIG. 7 illustrates exemplary components of address validation subsystem 106. As shown, address validation subsystem 106 may include a communication facility 702, a data update facility 704, a validation facility 706, and a storage facility 708 storing a repository of address data 710. Facilities 702-708 may be in communication with one another using any suitable communication technologies.

Communication facility 702 may include any communication technologies suitable for communicating with management subsystem 102. Accordingly, communication facility 702 may receive data representative of inventory data 310 from management subsystem 102 for validation and may transmit data representative of results of the validation to management subsystem 102.

Communication facility 702 may also include any communication technologies suitable for communicating with one or more computing devices from which address data may be received for inclusion in the repository of address data 710. Accordingly, communication facility 702 may receive data representative of address data from an external source, such as a third party providing the address data as a service.

Data update facility 704 may be configured to update address data included in the repository of address data 710 stored in storage facility 708. As an example, communication facility 702 may receive updated address data from a third party computing device, and data update facility 704 may update the repository of address data 710 with the received address data. Accordingly, the repository of address data 710 may include up-to-date address data that may be used to validate address data included in inventory data 310 as described herein.

Validation facility 706 may be configured to execute an address validation process on inventory data 310 by comparing address data included in the inventory data 310 to address data included in the repository of address data 710 and detecting any discrepancies that may be indicative of error conditions in the address data of the inventory data 310. In certain embodiments, for example, the repository of address data 710 may include a database of postal addresses that have been verified by a third party, and validation facility 706 may compare address data in inventory data 310 to the postal addresses in the database to detect any discrepancies indicative of error conditions in inventory data 310. Examples of such address error conditions are described further below.

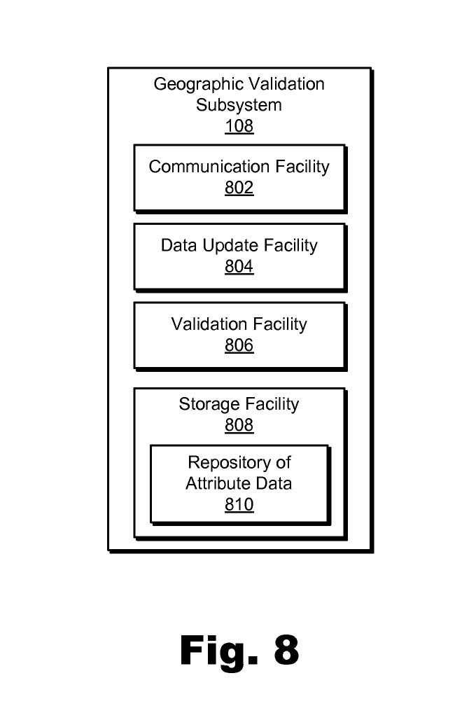

FIG. 8 illustrates exemplary components of geographic validation subsystem 108. As shown, geographic validation subsystem 108 may include a communication facility 802, a data update facility 804, a validation facility 806, and a storage facility 808 storing a repository of attribute data 810. Facilities 802-808 may be in communication with one another using any suitable communication technologies.

Communication facility 802 may include any communication technologies suitable for communicating with management subsystem 102. Accordingly, communication facility 802 may receive data representative of inventory data 310 from management subsystem 102 for geographic validation and may transmit data representative of results of the geographic validation to management subsystem 102.

Communication facility 802 may also include any communication technologies suitable for communicating with one or more computing devices from which attribute data may be received for inclusion in the repository of attribute data 810. Accordingly, communication facility 802 may receive data representative of attribute data from an external source, such as a third party providing the attribute data as a service.

Data update facility 804 may be configured to update attribute data included in the repository of attribute data 810 stored in storage facility 808. As an example, communication facility 802 may receive updated attribute data from a third party computing device, and data update facility 804 may update the repository of attribute data 810 with the received attribute data. Accordingly, the repository of attribute data 810 may include up-to-date attribute data.

Attribute data may include, but is not limited to, any data representative of street address information, tax jurisdiction information (e.g., data indicating one or more tax jurisdictions and/or tax jurisdictional attributes), and geographic location information such as latitude and longitude coordinates associated with street addresses and/or tax jurisdictions. For example, attribute data may indicate tax jurisdictions (e.g., states, counties, cities, school districts, special districts, enhanced communities, and other tax jurisdictions) that encompass or are otherwise associated with particular geographic locations (e.g., latitude and longitude coordinates) and/or street addresses.

Validation facility 806 may be configured to execute a geographic validation process on inventory data 310. The geographic validation process may be executed in any of the ways described herein and may be configured to determine whether street addresses in inventory data 310 are geographically matched to up-to-date tax jurisdictions and their corresponding tax jurisdictional attributes.

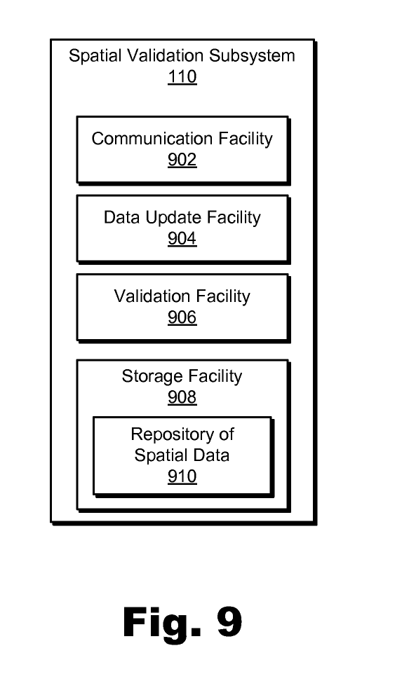

FIG. 9 illustrates exemplary components of spatial validation subsystem 110. As shown, spatial validation subsystem 110 may include a communication facility 902, a data update facility 904, a validation facility 906, and a storage facility 908 storing spatial data in a repository of spatial data 910. Facilities 902-908 may be in communication with one another using any suitable communication technologies.

Communication facility 902 may include any communication technologies suitable for communicating with management subsystem 102. Accordingly, communication facility 802 may receive data representative of inventory data 310 from management subsystem 102 for spatial validation and may transmit data representative of results of the spatial validation to management subsystem 102.

Communication facility 902 may also include any communication technologies suitable for communicating with one or more computing devices from which spatial data may be received for inclusion in the repository of spatial data 910. Accordingly, communication facility 902 may receive data representative of spatial data from an external source, such as a third party providing the spatial data as a service.

Data update facility 904 may be configured to update spatial data included in the repository of spatial data 910 stored in storage facility 908. As an example, communication facility 902 may receive updated spatial data from a third party computing device, and data update facility 904 may update the repository of attribute data 910 with the received spatial data. Accordingly, the repository of spatial data 910 may include up-to-date data.

Spatial data in the repository of spatial data 910 may include any data that may be used execute a spatial validation process on inventory data 310. For example, spatial data may represent a geometric shape (e.g., a line, point, or polygon) that may be used for spatial validation of inventory data 310.

Validation facility 906 may be configured to execute a spatial validation process to validate inventory data 310. The spatial validation process may be executed in any of the ways described herein and may be configured to determine, based on spatial relationships, whether a street address is appropriately matched to one or more tax jurisdictions. Additionally or alternatively, the spatial validation process may determine, based on spatial relationships, a confidence level to be associated with a determined relationship between a street address and one or more tax jurisdictions.

Exemplary methods of managing inventory data, including methods of auditing the inventory data will now be described.

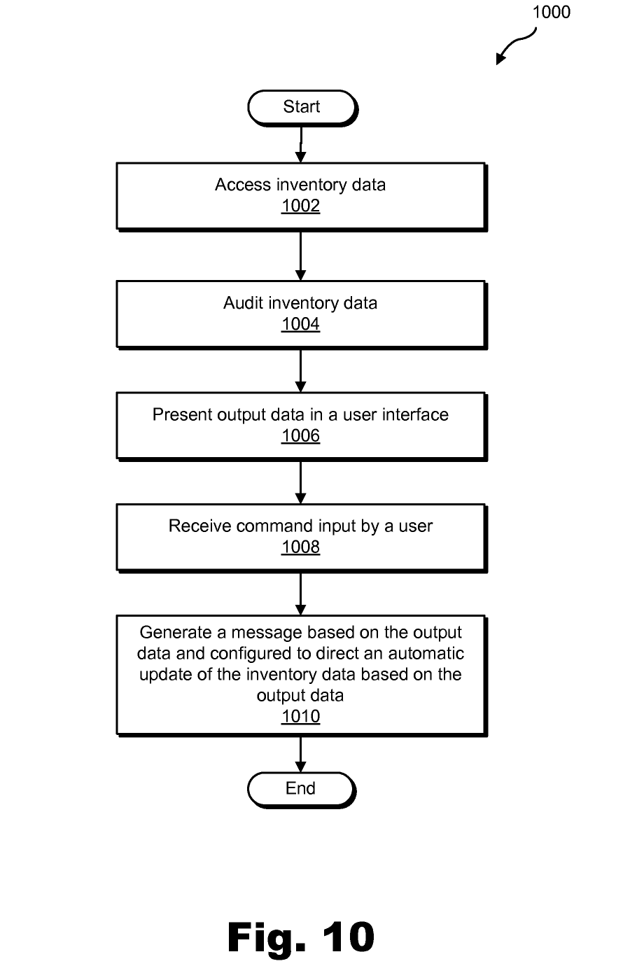

FIG. 10 illustrates an exemplary method 1000 of managing inventory data. While FIG. 10 illustrates exemplary steps according to one embodiment, other embodiments may omit, add to, reorder, combine, and/or modify any of the steps shown in FIG. 10. One or more of the steps shown in FIG. 10 may be performed by any component or components of system 100.

In step 1002, inventory data is accessed. For example, management subsystem 102 may access inventory data in the repository of inventory data 208 from maintenance subsystem 104 and/or audit processing facility 306 may access inventory data 310 in storage facility 308.

In step 1004, the inventory data is audited. For example, audit processing facility 306 may execute an audit process to audit the inventory data in any of the ways described herein. In some examples, the audit may include audit processing facility 306 accessing a data record included in the inventory data and representative of a range of street addresses and a tax code identifier associated with the range of street addresses and subjecting the data record to at least one of a validation process, a range split condition check process, and a tax code identifier check process as described herein. The audit may further include generating output data representative of a result produced by the validation process, range split condition check process, and/or tax code identifier check process. In some examples, the result may indicate an error condition associated with the inventory data, and the output data may be configured to facilitate a correction of the error condition in the inventory data.

In some examples, the subjecting of the data record to at least one of the validation process, the range split condition check process, and the tax code identifier check process in step 1004 may include subjecting the data record to the validation process, determining, based on the validation process, whether an error associated with the range of street addresses exists, executing the range split condition check process in response to a determination that the error associated with the range of street addresses does not exist, determining, based on the range split condition check process, whether an attribute mismatch exists within the range of street addresses, and executing the tax code identifier check process in response to a determination that the attribute mismatch does not exist within the range of street addresses.

In step 1006, the output data is presented in a user interface. For example, user interface facility 302 may present the output data in the user interface for consideration by a user.

In step 1008, a command input by a user is received. For example, the user may consider the output data presented in the user interface and provide input indicating the user's approval of the output data. The user may provide, and user interface facility 302 may receive, the command in any suitable way.

In step 1010, a message is generated based on the output data. The message may be configured to direct an automatic update of the inventor data based on the output data. For example, audit processing facility 306 may generate the message, and communication facility 304 may transmit the message to maintenance subsystem 102, which may automatically update inventory data included in the repository of inventory data 208 in accordance with the message.

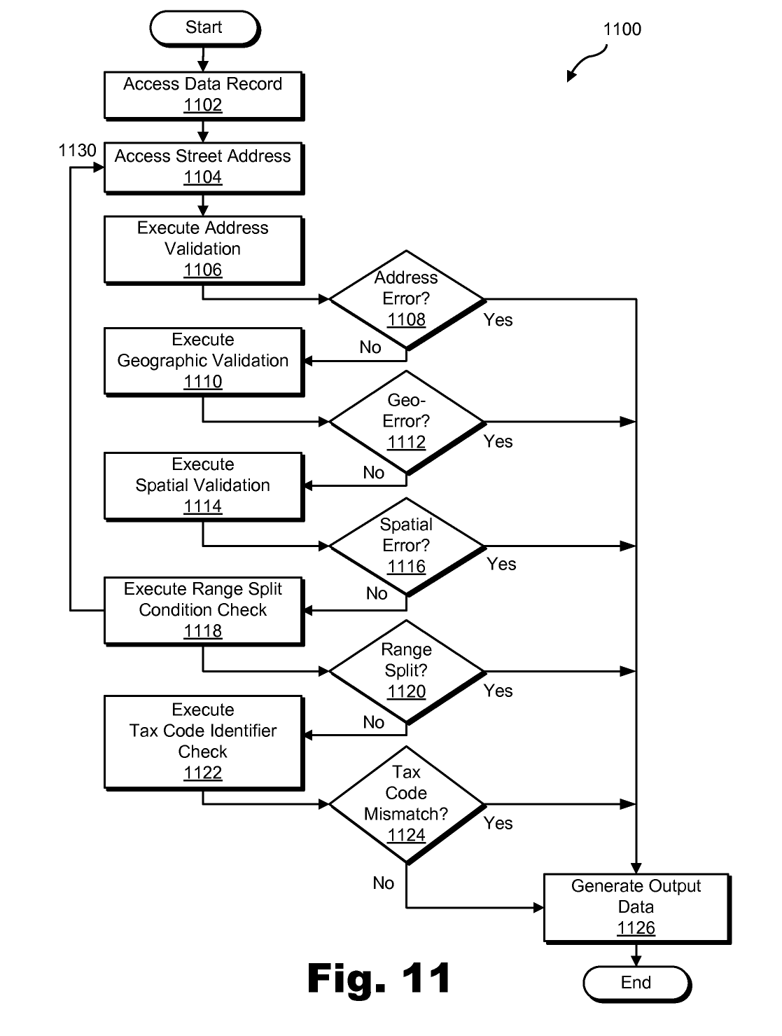

FIG. 11 illustrates an exemplary method 1100 of auditing inventory data. While FIG. 11 illustrates exemplary steps according to one embodiment, other embodiments may omit, add to, reorder, combine, and/or modify any of the steps shown in FIG. 11. One or more of the steps shown in FIG. 11 may be performed by any component or components of system 100.

In step 1102, a data record is accessed. For example, audit processing facility 306 may access a data record (e.g., data record 402-1) included in inventory data 310. As described herein, the data record may include data representative of a range of street addresses, a range type, address data, and a tax code identifier, such as is illustrated in FIG. 4.

In step 1104, a street address within the range of street addresses represented by the data record is accessed. For example, audit processing facility 306 may access a starting street address (e.g., a low street number) within the range of street addresses represented by the data record.

In step 1106, an address validation process is executed. For example, address data specified in the data record for the street address accessed in step 1104 may be validated by comparing the address data to address data maintained in the repository of address data 710 by address validation subsystem 106. In certain examples, audit processing facility 306 may provide data representative of the address data specified in the data record to address validation subsystem 106, which may execute an address validation process to compare the data record address data to the address data in the repository of address data 710. Based on the comparison, address validation subsystem 106 may detect any address errors such as any discrepancies between the data record address data and the address data in the repository and address data 710 and provide data representative of any errors or lack thereof to audit processing facility 306.

In step 1108, a determination is made, based on the validation process executed in step 1106, as to whether the address data for the street address accessed in step 1104 includes an address error. For example, audit processing facility 306 may determine, based on data received from address validation subsystem 106, whether any errors such as discrepancies between the data record address data and the address data in the repository of address data 710 were detected. Examples of address errors that may be detected by the address validation process executed in step 1106 are described further below. When no address error is detected, processing will move from step 1108 to step 1110.

In step 1110, a geographic validation process is executed. For example, audit processing facility 306 may provide address data associated with the street address accessed in step 1104 to geographic validation subsystem 108, which may use the address data to identify attribute data stored in the repository of attribute data 810 that is associated with the address data. For instance, validation facility 806 of geographic validation subsystem 108 may use the address data received from audit processing facility 306 to search the repository of attribute data 810 to identify attribute data that is associated with the address data. As mentioned, attribute data included in the repository of attribute data 810 may include street address information, tax jurisdiction information (e.g., data indicating one or more tax jurisdictions and/or tax jurisdictional attributes), and geographic location information such as latitude and longitude coordinates associated with street addresses and/or tax jurisdictions. Accordingly, the geographic validation process may include identifying attribute data, such as street address information, tax jurisdiction information, and latitude and longitude coordinates, that is related to the data record address information. For a particular street address in the range of street addresses, for example, validation facility 806 may search the repository of attribute data 810 to identify street address information, tax jurisdiction information, and latitude and longitude coordinates associated with the street address. This information may be used in subsequent steps of method 1100.

Step 1110 may further include determining a match level associated with the attribute data identified as being associated with the address data. For example, a determination may be made as to whether the street address specified in the data record and the latitude and longitude coordinates included in the attribute data indicate a “street level match,” which may be defined to represent a predetermined level of accuracy. For instance, a street level match may be defined to include a “rooftop” match indicating that the geographic location specified by the street address in the data record and the geographic location specified by the latitude and longitude coordinates of the attribute data are in alignment (e.g., the coordinates fall within the rooftop and/or property boundary associated with the street address). Alternatively or additionally, a street level match may be defined to include an instance when a geographic area specified by a zip code centroid (e.g., a ZIP+4 centroid) contains the geographic location specified by the latitude and longitude coordinates. When a street level match is determined to exist in step 1110, validation facility 806 may output an indicator of the existence of a street level match.

On the other hand, if a street level match is determined to not exist in step 1110, validation facility 806 may perform additional processing to determine whether a street level match exists based on additional or alternative criteria. In certain embodiments, the additional processing may include validation facility 806 accessing enhanced attribute data from the repository of attribute data 810 and using the enhanced attribute data (e.g., geo-code and/or map data) for the additional processing. For example, the additional processing may include determining a distance between the geographic location of the street address specified in the data record and the geographic location specified by the latitude and longitude coordinates in the attribute data. The distance may be compared with one or more other distances between the geographic location of the street address specified in the data record and one or more geographic locations specified by other latitude and longitude coordinates in the attribute data. Based on the comparison, the latitude and longitude coordinates nearest the geographic location specified by the street address data may be determined. When the initially identified latitude and longitude coordinates are determined to be nearest to the geographic location specified by the street address based on the geo-code and/or map data, the additional processing may indicate that a street level match exists based on the distance comparison.

In step 1112, a determination is made, based on the geographic validation process executed in step 1110, as to whether a geographic error (“geo-error”) exists. For example, if a street level match is determined to not exist in step 1110, step 1112 may include a determination that a geographic error exists. Conversely, if a street level match is found in step 1110, step 1112 may include a determination that no geographical error exists. When no geographical error is detected, processing will move from step 1112 to step 1114.

In step 1114, a spatial validation process is executed. The spatial validation process may include any spatial analysis configured to determine whether a geographic location is located within a geometric shape and/or in which of a plurality of geometric shapes the geographic location is located. For example, the spatial validation process may include a “point-in-polygon” analysis configured to determine whether a point (e.g., a geographic location indicated by a street address or geographic coordinates) is located within a polygon and/or in which of a plurality of polygons the point is located. An area covered by any of a variety of geometric shapes, including a point and a line, may be treated as a polygon and used for point-in-polygon analysis. To illustrate, geographic areas covered by tax jurisdictions may be treated as polygons, and the polygons may be searched to determine in which of the polygons a point marked by latitude and longitude coordinates identified in step 1110 as being associated with a street address is located.

The spatial validation process may further include determining a confidence level to be associated with results of the spatial analysis. The confidence level may indicate a quantified level of confidence that a point is located within a polygon. In certain embodiments, the confidence level may be based on a size of a polygon. For example, if a radius of a polygon is relatively large, a relatively high confidence level may be assigned. On the other hand, if a radius of the polygon is relatively small, a relatively low confidence level may be assigned. Alternatively or additionally, the confidence level may be based on a distance of the point within polygon from a border of the polygon. For example, if the distance from the point to a border of the polygon is greater than a predefined distance threshold, the confidence level may be increased to indicate a higher level of confidence that the point is within the polygon.

In step 1116, a determination is made, based on the spatial validation process executed in step 1114, as to whether a spatial error exists. For example, if a spatial analysis performed in step 1114 fails to determine that a point is located within a geometric shape with at least a predefined level of confidence, step 1116 may include a determination that a spatial error exists. Conversely, if the spatial analysis performed in step 1114 determines that the point is located within the geometric shape with at least the predefined level of confidence, step 1116 may include a determination that no spatial error exists. When no spatial error is detected, processing will move from step 1116 to step 1118.

At least one of the address, geographic, and spatial validation processes described herein may help improve the accuracy of inventory data 310 and/or audits of inventory data 310. For example, by executing one or more of the address, geographic, and spatial validation processes before executing further auditing processes, only accurate address, geographic, and/or spatial data will be used for the further auditing processing. In certain embodiments, for example, only after a street address within a range of street addresses has been validated by the address, geographic, and spatial validation processes will range split conditions be checked in the range of street addresses at step 1118. As used herein, a “validation process” may refer to the address, geographic, and/or spatial validation processes collectively, individually, or in combination or sub-combination.

In step 1118, a range split condition check process is executed to check for a range split condition within the range of street addresses represented by the data record. For example, audit processing facility 306 may use data returned by the validation processes executed in steps 1106, 1110, and 1114 to determine whether a range split condition exists within the range of street addresses represented by the data record. A range split condition may include an attribute mismatch between street addresses included in the range of street addresses. For instance, a first street address within the range of street addresses may be determined to be associated with a first set of tax jurisdictional attributes, and another street address within the range of street addresses may be determined to be associated with a different set of tax jurisdictional attributes. Accordingly, a mismatch of tax jurisdictional attributes may be determined to exist between the street addresses included in the range of street addresses. Such a mismatch may be indicative of a range split condition.

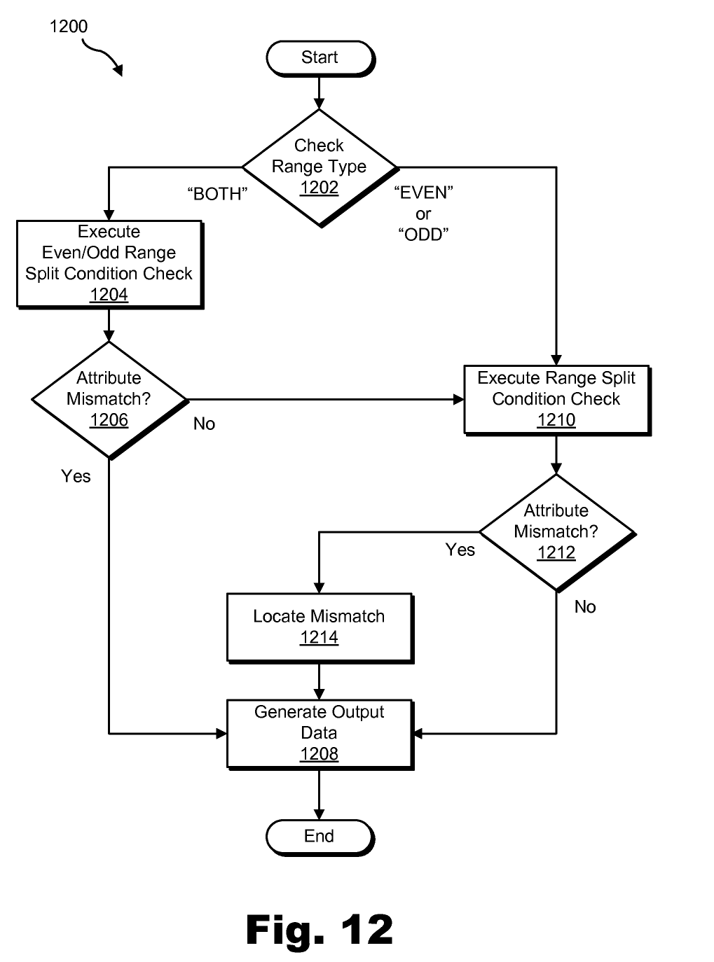

FIG. 12 illustrates an exemplary method 1200 of checking for a split condition in a range of street addresses. While FIG. 12 illustrates exemplary steps according to one embodiment, other embodiments may omit, add to, reorder, combine, and/or modify any of the steps shown in FIG. 12. One or more of the steps shown in FIG. 12 may be performed by any component or components of system 100.

In step 1202, a range type is checked. For example, data representative of a range type may be included in the data record accessed in step 1102 of FIG. 11 and may be used to determine a range type assigned to the range of street addresses represented by the data record. In certain embodiments, the range type may indicate whether the range of street addresses represented by the data record includes only even-numbered street addresses (e.g., the range type equals “EVEN”), only odd-numbered street addresses (e.g., the range type equals “ODD”), or both even-numbered and odd-numbered street addresses (e.g., the range type equals “BOTH”).

When a determination is made at step 1202 that the range of street addresses represented by the data record includes both even-numbered and odd-numbered street addresses, processing may move from step 1202 to step 1204. In step 1204, an “even-odd” range split condition check process is executed. The even-odd range split condition check process may be configured to determine whether an attribute mismatch exists between even-numbered and odd-numbered street addresses in the range of street addresses represented by the data record. The even-odd range split condition check process may include comparing attributes of even-numbered and odd-numbered street addresses within the range of street addresses. In certain embodiments, for example, the even-odd range split condition check process may compare attributes of three consecutive street addresses within the range of street addresses, such as the first, second, and third street addresses within the range of street addresses. Typically, the first and the third street addresses may be odd-numbered street addresses, and the second street address may be an even-numbered street address. Accordingly, when the attributes associated with the first, second, and third street addresses are compared, any attribute mismatch between the attributes of the second street address and the attributes of the first and the third street addresses may be detected. An attribute mismatch between the attributes of the second street address and the attributes of the first and third street addresses, coupled with a lack of an attribute mismatch between the attributes of the first street address and the attributes of the third street address, may be indicative of an even-odd attribute mismatch within the range of street addresses. For example, even-numbered street addresses located on one side of a street may be associated with a set of tax jurisdiction attributes, and odd-numbered street addresses located on the other side of the street may be associated with a different set of tax jurisdiction attributes.

To perform a comparison of attributes of even-numbered street addresses and attributes of odd-numbered street addresses within a range of street addresses, the even-odd range split condition check process may utilize a step-increment counter. After steps 1104-1116 of FIG. 11 have been performed for a first street address within the range of street addresses represented by the data record as described above, the even-odd range split condition check process may utilize the step-increment counter to initiate execution of steps 1104-1116 for the next sequential street address within the range of street addresses, e.g., the second street address in the range of street addresses. After steps 1104-1116 of FIG. 11 have been performed for the second street address within the range of street addresses represented by the data record, the even-odd range split condition check process may utilize the step-increment counter to initiate execution of steps 1104-1116 for the next sequential street address within the range of street addresses, e.g., the third street address in the range of street addresses. FIG. 11 shows an arrow 1130 connecting step 1118 to step 1104 to represent a processing loop that may be repeated to perform steps 1104-1116 for different street addresses within the range of street addresses. After steps 1104-1116 of FIG. 11 have been performed for the first three consecutive street addresses within the range of street addresses without detecting an error associated with the three street addresses, the even-odd range split condition check process may compare the attributes that have been determined to be associated with the first three street addresses.

In step 1206 of FIG. 12, a determination is made as to whether an attribute mismatch exists between the attributes of the street addresses checked in step 1204. For example, audit processing facility 306 may determine, based on one or more comparisons made in the even-odd range split condition check process in step 1204, whether an attribute mismatch exists. When an attribute mismatch is determined to exist in step 1206, the attribute mismatch may be determined to be indicative of an even-odd range split condition within the range of street addresses. That is, even-numbered and odd-numbered street addresses within the range of street addresses are determined to be associated with different attributes such as different tax jurisdictional attributes. When such an attribute mismatch is found in step 1206, processing moves from step 1206 to step 1208.

In step 1208, output data is generated based on the attribute mismatch detected in step 1206. Output data generated based on the attribute mismatch detected in step 1206 may include data indicating that an even-odd attribute mismatch has been detected. As described further below, the output data may be configured to facilitate a split of the range of street addresses into an even-numbered range of street addresses and an odd-numbered range of street addresses based on the attribute mismatch.

Returning to step 1206, when an attribute mismatch is determined to not exist based on the even-odd range split condition check process executed in step 1204, processing may move from step 1206 to step 1210. Similarly, processing may move directly from step 1202 to step 1210 to bypass the even-odd range split condition check process when the range of street addresses represented by the data record accessed in step 1102 of FIG. 11 is determined to be of a range type that includes only even-numbered or odd-numbered street addresses in step 1202.

In step 1210, a range split check process is executed. The range split check process executed in step 1210 may be configured to determine whether an attribute mismatch exists within the range of street addresses represented in the data record. The range split check process executed in step 1210 is typically configured to search for attribute mismatches not associated with even-odd attribute mismatches, which are detected by the even-odd range split check process executed in step 1204 as described above.

The range split condition check process executed in step 110 may comprise a segment-increment-based range split condition check process configured to process the range of street addresses using a segment-increment counter whenever the range of street addresses has a length greater than a predefined segment length. Accordingly, the process executed in step 1110 may include determining whether the length of the range of street addresses is greater than the predefined segment length. If it is not, the process in step 1210 may be executed using a step-increment counter such that each of the street addresses within the range of street addresses is incrementally and consecutively processes to compare attributes of the street addresses to identify any attribute mismatch.

On the other hand, if the length of the segment is less than the length of the range of street addresses, the process in step 1210 may be executed using a segment-increment counter such that segments of street addresses within the range of street addresses are processed segment-by-segment. Each segment may be processed by comparing attributes of select street addresses to identify whether an attribute mismatch exists within a segment of street addresses. For example, after steps 1104-1116 of FIG. 11 have been performed for a first street address (i.e., a starting street address) within the range of street addresses represented by the data record as described above, the range split condition check process of step 1210 may utilize a segment-increment counter to initiate execution of steps 1104-1116 for an ending street address of a segment of street addresses within the range of street addresses. The attributes of the starting street address of the range of street addresses may be compared to the attributes of the segment ending street address to determine whether an attribute mismatch exists between the street addresses and consequently within the segment of street addresses. If no attribute mismatch is detected in the segment, the process of step 1210 may continue by processing another segment, which may be determined by using the segment-increment counter to locate an ending street address of the next segment of street addresses within the range of street addresses. The execution of the process of step 1210 may continue until an attribute mismatch is detected or until all segments within the range of street addresses have been checked without finding an attribute mismatch.

In step 1212 of FIG. 12, a determination is made as to whether an attribute mismatch exists between the attributes of the street addresses checked in step 1210. For example, audit processing facility 306 may determine, based on one or more comparisons made in the range split condition check process in step 1210, whether an attribute mismatch exists. When an attribute mismatch is not found in step 1210, processing will move from step 1212 to 1208. In step 1208, output data is generated based on the absence of an attribute mismatch in the range of street addresses. Such output data may indicate that no attribute mismatch was detected within the range of street addresses represented by the data record.

Conversely, when an attribute mismatch is determined to exist within the range of street addresses based on the process executed in step 1210, processing will move from step 1212 to step 1214. In step 1214, the attribute mismatch detected in step 1210 is located. This may include identifying a particular street address within the range of street addresses at which the attribute mismatch begins, which may be referred as a starting point of the attribute mismatch within the range of street addresses.

In certain embodiments, the starting point of the attribute mismatch may be located by first using the segment-increment counter to go back the length of a segment within the range of address addresses and then using a step-increment counter to incrementally and consecutively process each street address within the segment length until a starting point of the attribute mismatch is located. After the attribute mismatch is located in step 1214, processing will move to step 1208. In step 1208, output data representative of the attribute mismatch and its location within the range of street addresses is generated.

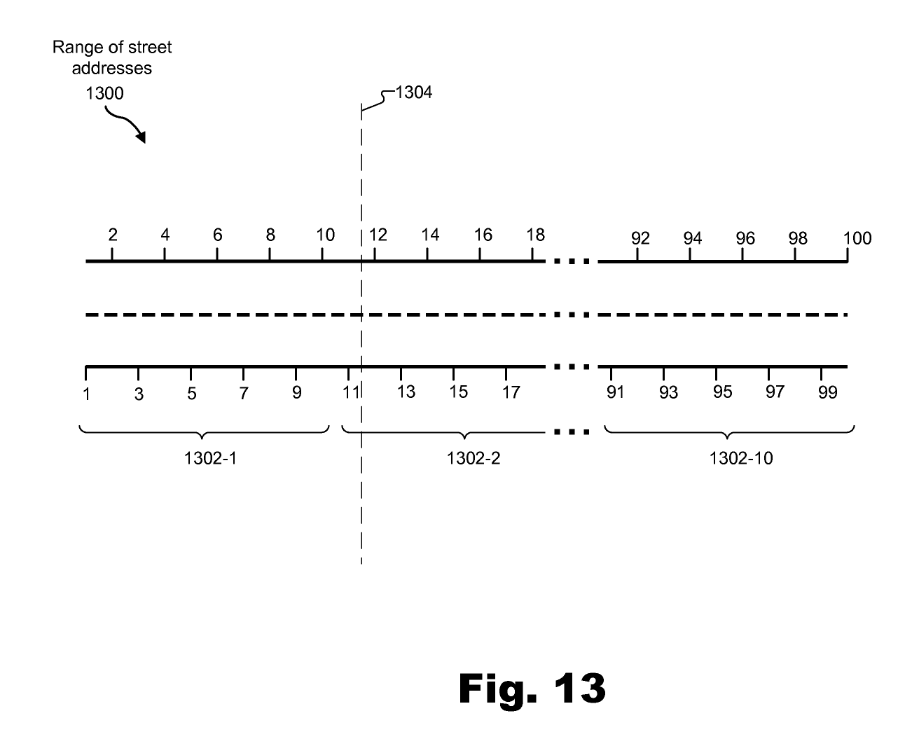

To further illustrate method 1200, an example of checking for a range split condition in an exemplary range of street addresses will now be described with reference to FIG. 13. FIG. 13 illustrates an exemplary range of street addresses 1300. As shown, the range of street addresses 1300 includes numerical street addresses 1-100, with odd-number street addresses 1-99 positioned on one side of a street, and even-numbered street addresses 2-100 positioned on the other side of the street. The range of street addresses 1300 may be represented by a data record in inventory data 310, and system 100 may audit the range of street addresses 1300 as described herein. For example, management subsystem 102 may access the data record representative of the range of street addresses 1300. Management subsystem 102 and then access the first street address (e.g., street number 1) within the range of street addresses 1300 and subject the first street address to address, geographic, and spatial validation processing as described above. When no errors are found by the address, geographic, or spatial validation processing, management subsystem 102 may check for a range split condition within the range of street addresses 1300.

To illustrate, management subsystem 102 may check the range type of the range of street addresses 1300 and determine that the range of street addresses 1300 contains both even-numbered an odd-numbered street addresses. Accordingly, management subsystem 102 may subject the range of street addresses 1300 to an even-odd range split condition check process. For example, management subsystem 102 may increment a counter to move validation processing from the first street address to the second street address (e.g. street number 2) within the range of street addresses 1300. Accordingly, management subsystem 102 may subject the second street address to address, geographic, and spatial validation processing as described above. When no errors are found by the address, geographic, or spatial validation processing, management subsystem 102 may increment the counter to move validation processing from the second street address to a third street address (e.g., street number 3) within the range of street addresses 1300. Accordingly, the third street address may be subjected to address, geographic, and spatial allocation processing as described above. When no errors are found by the address, geographic, or spatial validation processing, management subsystem 102 may compare attributes for the first, second, and third street addresses within the range of street addresses 1300 to identify any attribute mismatch indicative of attribute discrepancies between even-numbered and odd-numbered street addresses. When no attribute mismatch is detected between the second street address and the first and third street addresses within the range of street addresses 1300, management subsystem 102 may determine that an even-odd range split condition does not exist within the range of street addresses 1300.

Management subsystem 102 may then subject the range of street addresses 1300 to a segment-based range split condition check process. In this process, management subsystem 102 may use the attribute data for the first street address obtained from the address, geographic, and/or spatial validation processing of the first street address. Management subsystem 102 may then determine whether the length of the range of street addresses 1300 is greater than a predefined segment length. A segment length of ten street addresses will be used for this example. As shown in FIG. 13, the range of street addresses 1300 may be divided into segments 1302 (e.g., segments 1302-1 through 1302-10) each having a length of ten street addresses. With a segment length of ten street addresses, management subsystem 102 may determine that the length of the range of street addresses 1300 (one hundred street addresses) is greater than the predefined segment length. In response, management subsystem 102 may process the range of street addresses 1300 segment-by-segment.

To illustrate, management subsystem 102 may increment a counter by the predefined segment length such that after the first street address is validated, management subsystem 102 may subject a street address associated with an ending point of a segment of street addresses to validation processing. For example, management subsystem 102 may subject the tenth street address within the range of street addresses 1300 (street number 10) to address, geographic, and spatial validation processing. If no validation errors are detected, management subsystem 102 may compare attribute data of the starting street address within the range of street addresses 1300 (street number 1) to attribute data of the ending street address of the segment of street addresses 1302-1 within the range of street addresses 1300 (i.e., compare attribute data of street number 1 to attribute data of street number 2).

If no attribute mismatch is detected within the segment 1302-1 spanning the first street address to the tenth street address in the range of street addresses 1300, the next segment 1302-2 within the range of street addresses 1300 may be checked for an attribute mismatch. For example, management subsystem 102 may increment the counter by the segment length such that the twentieth street address within the range of street addresses may be subjected to validation processing and the attribute data of the twentieth street address compared to the attribute data of the first street address (i.e., attribute data of street number 20 to attribute data of street number 1) to identify any attribute mismatch within the second segment 1302-2.

If an attribute mismatch is detected between the attribute data of the first street address and the attribute data of the twentieth street address within the range of street addresses 1300, management subsystem 102 may determine that the attribute mismatch begins within the second segment 1302-2 spanning the eleventh street address to the twentieth street address within the range of street addresses 1300. Accordingly, management subsystem 102 may roll back the counter to the first street address within the second segment 1302-2 and consecutively and incrementally process each of the street addresses within the segment 1302-2 until a starting point of the attribute mismatch is located.

For example, management subsystem 102 may subject the eleventh street address within the range of street addresses 1300 to validation processing and compare attribute data for the eleventh street address (i.e., street number 11) to attribute data for the first street address (i.e., street number 1) to identify any attribute mismatch. When no attribute mismatch is detected between the first and the eleventh street addresses, management subsystem 102 may increment the counter by one step in order to subject the twelfth street address to validation processing and compare the attribute data of the twelfth street address to the attribute data for the first street address to identify any mismatches.

When an attribute mismatch is detected between the first and twelfth street addresses, management subsystem 102 may identify the twelfth street address as a starting point of the attribute mismatch within the range of street addresses 1300. For example, a tax jurisdiction may have a boundary 1304 that runs between the eleventh and twelfth street addresses as shown in FIG. 13. Accordingly, street address numbers 1-11 may be associated with a set of attribute data that is different from a set of attribute data associated with street address numbers 12-100 of the range of street addresses 1300. Management subsystem 102 may generate output data indicative of an attribute mismatch within the range of street addresses 1300 and of a starting point (e.g., street address number 12) of the attribute mismatch within the range of street addresses 1300. Accordingly, the output data may be configured to facilitate a splitting of the range of street addresses 1300 into a first range of street addresses spanning street address numbers 1-11 and a second range of street addresses spanning street address numbers 12-100.

Returning to FIG. 11, in step 1120, a determination may be made as to whether a range split condition has been detected within the range of street addresses. When no range split condition is detected within the range of street addresses, processing will move from step 1120 to step 1122.

In step 1122, a tax code identifier check process is executed. The tax code identifier check process may be configured to detect whether a tax code identifier associated with the range of street addresses in inventory data 310 matches or does not match a tax code identifier associated with the attribute data obtained during validation processing. To illustrate, audit processing facility 306 may use the attribute data obtained during validation processing of the range of street addresses to search tax translation data 312 to identify a tax code identifier that is mapped to the set of attribute data in text translation data 312. When the tax code identifier mapped to a set of attribute data in tax translation data 312 is found and compared to the tax code identifier associated with the range of street addresses in inventory data 310.

In step 1124, a determination is made as to whether a tax code identifier mismatch exists. For example, audit processing facility 306 may determine, based on the comparison made in step 1122, whether the tax code identifier mapped to the set of attribute data in tax translation data 312 matches the tax code identifier associated with the range of street addresses in inventory data 310. If a match is determined to exist, a tax code identifier mismatch is not detected in step 1124. Otherwise, in step 1124, a tax code identifier mismatch is detected to exist between inventory data 310 and the tax translation data 312. In either case, processing will move from step 1124 to step 1126 in FIG. 11.

In certain cases, a set of attribute data determined to be associated a range of street addresses represented by a data record may not be included in tax translation data 312. Accordingly, audit processing facility 306 may search for but not find the set of attribute data in tax translation data 312. In response, audit processing facility 306 may insert data representative of the set of attribute data in tax translation data 312 (e.g., as a new row 606 in data table 600 of FIG. 6). The tax code identifier indicated in the data record may also be inserted and mapped to the set of attribute data in tax translation data 312 (e.g., as an old tax code identifier in the “previous tax code” column in table 600). Audit processing facility 306 may also insert and/or map an empty data field associated with a new or current tax code identifier to the set of attribute data in tax translation data 312 (e.g., as a new tax code identifier in the “current tax code” column in table 600).

Management subsystem 102 may be further configured to execute a process configured to search for and detect any empty new tax code fields in tax translation data 312. For example, management subsystem 102 may detect any empty fields within the “current tax code” column in table 600. When such an empty field is detected in tax translation data 312, management subsystem 102 may generate and provide a message representative of the detected empty field and corresponding mapped set of attribute data to tax code maintenance subsystem 112 for use by tax code maintenance subsystem 112 and/or a user of tax code maintenance subsystem 112 to find and assign a new tax code identifier to the new set of attribute data. Accordingly, tax translation data 508 in storage facility 506 may be updated to include the new tax code identifier mapped to the new set of attribute data. The updates may be propagated to tax translation data 312 in any suitable way. In certain embodiments, the detection of empty tax code identifier fields in tax translation data 312 and providing of corresponding notification messages to tax code maintenance subsystem 112 may be performed periodically, such as in a scheduled (e.g., nightly) process.

In step 1126, output data is generated. The output data may be generated based on the results of one or more steps of FIG. 11. As shown in FIG. 11, processing may move to step 1126 when an address error is detected in step 1108, a geo-error is detected in step 1112, a spatial error is detected in step 1116, a range split condition is detected in step 1120, a tax code mismatch is detected in step 1124, or a tax code mismatch is not detected in step 1124. The output data generated in step 1126 will differ based on the results determined in step 1108, 1112, 1116, 1120, or 1124. For example, when an address error is detected in step 1208, output data indicative of the address error will be generated in step 1126 and method 1100 will end without execution of steps 1110-1124. When a geo-error is detected in step 1112, output data indicative of the geo-error will be generated in step 1126 and method 1100 will end without execution of steps 1114-1124. When a spatial error is detected in step 1116, output data indicative of the spatial error will be generated in step 1126 and method 1100 will end without execution of steps 1118-1124. When a range split condition is detected in step 1120, output data indicative of the range split condition will be generated in step 1126 and method 1100 will end without execution of steps 1122-1124. When a tax code identifier mismatch is detected in step 1124, output data indicative of the tax code identifier mismatch will be generated in step 1126. When a tax code mismatch is not detected in step 1124, output data indicative of a lack of errors in the range of street addresses 1300 will be generated at step 1126, indicating that the range of street addresses 1300 has successfully passed the audit process.

Examples of output that may be generated in step 1126 will now be described. The examples may be associated with error code identifiers, which may be specified in the output data. The examples are illustrative only and not limiting in any sense.

When an address error is detected in step 1108, the output data generated in step 1126 may represent any detected address errors, including any of the following types of address errors: street addresses not validated against address data in the inventory of address data 710, street addresses not matched or not uniquely matched to address data in the inventory of address data 710 because of incomplete or insufficient address information, street names not found in the inventory of address data 710, zip codes not found in the inventory of address data 710, no directional information in data record when directional information is included in the inventory of address data 710, no suffix information in data record when suffix information is included in the inventory of address data 710, no unit identifier (e.g., apartment number) in data record when unit identifier is included in the inventory of address data 710, city and/or state information not matched in the inventory of address data 710 for matched zip code, city name information not able to be determined for matched zip code, and direction or suffix information in data record not found in the inventory of address data 710.

When a range split condition is detected in step 1120, the output data generated in step 1126 may represent the range split condition. When a tax code identifier mismatch is detected in step 1124, the output data generated in step 1126 may represent the tax code identifier mismatch. In some examples, tax code mismatches may be divided into two categories—one for tax code identifier mismatches that are detected when street level matches have been detected, and one for tax code identifier mismatches that are detected when street level mismatches have not been detected.

In certain embodiments, one or more of the components and/or processes described herein may be implemented and/or performed by a computing system including one or more appropriately configured computing devices. To this end, one or more of the systems and/or components described above may include or be implemented by any computer hardware and/or computer-implemented instructions (e.g., software) embodied on at least one non-transitory computer-readable medium and configured to perform one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as tangibly embodied instructions executable by one or more computing devices. In general, a processor (e.g., a microprocessor) receives instructions, from a tangible computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

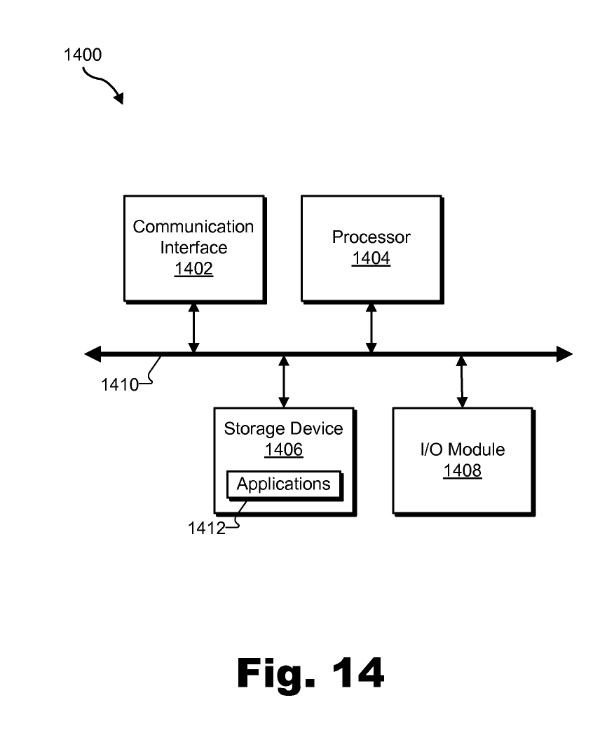

FIG. 14 illustrates an exemplary computing device 1400 that may be configured to perform one or more of the processes described herein. As shown in FIG. 14, computing device 1400 may include a communication interface 1402, a processor 1404, a storage device 1406, and an input/output (“I/O”) module 1408 communicatively connected via a communication infrastructure 1410. While an exemplary computing device 1400 is shown in FIG. 14, the components illustrated in FIG. 14 are not intended to be limiting. Additional or alternative components may be used in other embodiments. Components of computing device 1400 shown in FIG. 14 will now be described in additional detail.

Communication interface 1402 may be configured to communicate with one or more computing devices. Examples of communication interface 1402 include, without limitation, a wired network interface (such as a network interface card), a wireless network interface (such as a wireless network interface card), a modem, and any other suitable interface.

Processor 1404 generally represents any type or form of processing unit capable of processing data or interpreting, executing, and/or directing execution of one or more of the instructions, processes, and/or operations described herein. Processor 1404 may direct execution of operations in accordance with one or more applications 1412 or other computer-executable instructions such as may be stored in storage device 1406 or another computer-readable medium.

Storage device 1406 may include one or more data storage media, devices, or configurations and may employ any type, form, and combination of data storage media and/or device. For example, storage device 1406 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 1406. For example, data representative of one or more executable applications 1412 (which may include, but are not limited to, one or more of the software applications) configured to direct processor 1404 to perform any of the operations described herein may be stored within storage device 1406. In some examples, data may be arranged in one or more databases residing within storage device 1406.

I/O module 1408 may be configured to receive user input and provide user output and may include any hardware, firmware, software, or combination thereof supportive of input and output capabilities. For example, I/O module 1408 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1408 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 1408 is configured to provide graphical data to a display for presentation to a user. The graphical data may be representative of one or more graphical user interfaces and/or any other graphical content as may serve a particular implementation.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
accessing, by a computing system, inventory data maintained in a repository of inventory data, the inventory data maintained for use in determining tax revenue to be collected from at least one customer; and
auditing, by the computing subsystem, the inventory data, the auditing comprising
accessing a data record included in the inventory data, the data record representative of a range of street addresses and a tax code identifier associated with the range of street addresses,
subjecting the data record to at least one of a validation process, a range split condition check process, and a tax code identifier check process, and
generating output data representative of a result produced by the at least one of the validation process, the range split condition check process, and the tax code identifier check process, wherein when the result indicates an error condition, the output data is configured to facilitate a correction of the error condition in the inventory data included in the repository of inventory data.

2. The method of claim 1, further comprising:
presenting, by the computing system, data representative of the output data in a user interface for consideration by a user;
receiving, by the computing system, a command input by the user; and
generating, by the computing system in response to the command input by the user, a message based on the output data and configured to direct an automatic update of the inventory data in the repository of inventory data to correct the error condition based on the output data.

3. The method of claim 1, wherein:
the error condition comprises a tax jurisdictional attribute mismatch within the range of street addresses; and
the correction comprises a split of the range of street addresses based on the tax jurisdictional mismatch.

4. The method of claim 3, wherein the split of the range of street addresses is configured to split the range of street addresses into a range of even-numbered street addresses and a range of odd-numbered street addresses.

5. The method of claim 3, wherein the split of the range of street addresses is configured to split the range of street addresses into two ranges of street addresses at a starting point of the tax jurisdictional attribute mismatch within the range of street addresses.

6. The method of claim 1, wherein the range split condition check process comprises:
determining, by the computing system, that the range of street addresses includes even-numbered and odd-numbered street addresses; and
executing, by the computing system in response to a determination that the range of street addresses includes even-numbered and odd-numbered street addresses, an even-odd range split condition check process on the range of street addresses.

7. The method of claim 6, wherein the range split condition check process further comprises:
determining, by the computing system based on the even-odd range split condition check process, whether the range of street addresses includes an even-odd attribute mismatch; and
executing, by the computing system in response to a determination that the range of street addresses does not include the even-odd attribute mismatch, a segment-increment-based range split condition check process on the range of street addresses.

8. The method of claim 7, wherein the range split condition check process further comprises:
determining, by the computing system based on the segment-increment-based range split condition check process, whether the range of street addresses includes an attribute mismatch; and
locating, by the computing system in response to a determination that the range of street addresses includes the attribute mismatch, a starting point of the attribute mismatch within the range of street addresses.

9. The method of claim 7, wherein the segment-increment-based range split condition check process comprises:
comparing, by the computing system, attribute data associated with a starting street address of the range of street address to attribute data associated with an ending street address of a segment of street addresses within the range of street addresses; and
incrementally comparing, by the computing system in response to a detection of an attribute mismatch between the attribute data associated with the starting street address within the range of street addresses and the attribute data associated with the ending street address of the segment of street addresses within the range of street addresses, attribute data associated with each street address within the segment of street addresses with the attribute data associated to the starting street address of the range of street addresses until a starting point of the attribute mismatch within the range of street addresses is located.

10. The method of claim 1, wherein the range split condition check process comprises:
determining, by the computing system, that the range of street addresses includes only even-numbered or odd-numbered street addresses; and
executing, by the computing system in response to a determination that the range of street addresses includes only even-numbered or odd-numbered street addresses, a segment-increment-based range split condition check process on the range of street addresses.

11. The method of claim 1, wherein:
the validation process includes identifying, by the computing system, a set of attribute data associated with the data record; and
the tax code identifier check process comprises:
searching, by the computing system, tax translation data for the set of attribute data to identify a tax code identifier associated with the set of attribute data in the tax translation data; and
when the set of attribute data is located in the tax translation data, comparing a tax code identifier mapped to the set of attribute data in the tax translation data to the tax code identifier in the data record to determine whether a tax code identifier mismatch exists.

12. The method of claim 11, wherein when the set of attribute data is not located in the tax translation data, inserting, by the computing system, data representative of the set of attribute data in the tax translation data and generating a message configured to request a new tax code identifier for the set of attribute data.

13. The method of claim 1, wherein the subjecting of the data record to the at least one of the validation process, the range split condition check process, and the tax code identifier check process comprises:
subjecting the data record to the validation process;
determining, based on the validation process, whether an error associated with the range of street addresses exists,
executing the range split condition check process in response to a determination that the error associated with the range of street addresses does not exist;
determining, based on the range split condition check process, whether an attribute mismatch exists within the range of street addresses; and
executing the tax code identifier check process in response to a determination that the attribute mismatch does not exist within the range of street addresses.

14. The method of claim 1, wherein the validation process comprises at least one of an address validation process, a geographic validation process, and a spatial validation process.

15. The method of claim 1, embodied as computer-executable instructions on at least one non-transitory computer-readable medium.

16. A method comprising:
accessing, by a computing system, a data record representative of a range of street addresses and a tax code identifier associated with the range of street addresses;
executing, by the computing system, at least one validation process on the data record, wherein the at least one validation process includes obtaining attribute data associated with the range of street addresses and determining whether an error associated with the range of street addresses exists;
when the at least one validation process detects an error associated with the range of street addresses, generating, by the computing system, output data indicative of the error and configured to facilitate a correction of the error;
when the at least one validation process fails to detect an error associated with the range of street addresses, executing, by the computing system, a range split condition check process to determine, based on the attribute data associated with the range of street addresses, whether an attribute mismatch exists within the range of street addresses;
when the range split condition check process detects an attribute mismatch within the range of street addresses, generating, by the computing system, output data indicative of the attribute mismatch and configured to facilitate a split of the range of street addresses based on the attribute mismatch;
when the range split condition check process fails to detect an attribute mismatch within the range of street addresses, executing, by the computing system, a tax code identifier check process on the tax code identifier included in the data record;
when the tax code check process detects a tax code identifier mismatch, generating, by the computing system, output data indicative of the tax code identifier mismatch and configured to facilitate a correction of the tax code identifier mismatch; and
when the tax code identifier check process fails to detect a tax code identifier mismatch, generating, by the computing system, output data indicative of a lack of error for the range of street addresses represented by the data record.

17. The method of claim 16, wherein the at least one validation process comprises an address validation process, a geographic validation process, and a spatial validation process.

18. A system comprising:
an inventory data maintenance subsystem that maintains inventory data in a repository of inventory data for use in determining tax revenue to be collected from at least one customer; and
an inventory data management subsystem communicatively coupled to the inventory data maintenance subsystem and configured to
access the inventory data in the repository of inventory data, and
audit the inventory data, the audit comprising
accessing a data record included in the inventory data and including data representative of a range of street addresses and a tax code identifier associated with the range of street addresses,
subjecting the data record to at least one of a validation process, a range split condition check process, and a tax code check process, and
generating output data representative of a result produced by the at least one of the validation process, the range split condition check process, and the tax code check process, wherein when the result indicates an error condition, the output data is configured to facilitate a correction of the error condition in the inventory data included in the repository of inventory data.

19. The system of claim 18, wherein the inventory data management subsystem is further configured to
present data representative of the output data in a user interface for consideration by a user,
receive a command input by the user, and
generate, in response to the command input by the user, a message based on the output data and provide the message to the inventory data maintenance subsystem, the message configured to direct the inventory data maintenance subsystem to update the inventory data in the repository of inventory data based on the output data.

20. The system of claim 18, wherein:
the error condition comprises a tax jurisdictional attribute mismatch within the range of street addresses; and
the correction comprises a split of the range of street addresses based on the tax jurisdictional mismatch.

21. The system of claim 20, wherein the split of the range of street addresses is configured to split the range of street addresses into a range of even-numbered street addresses and a range of odd-numbered street addresses.

22. The system of claim 20, wherein the split of the range of street addresses is configured to split the range of street addresses into two ranges of street addresses at a starting point of the tax jurisdictional attribute mismatch within the range of street addresses.

23. The system of claim 18, wherein the inventory data management subsystem is configured to subject the data record to the at least one of the validation process, the range split condition check process, and the tax code identifier check process by:
subjecting the data record to the validation process;
determining, based on the validation process, whether an error associated with the range of street addresses exists,
executing, in response to a determination that the error associated with the range of street addresses does not exist, the range split condition check process;
determining, based on the range split condition check process, whether an attribute mismatch exists within the range of street addresses; and
executing, in response to a determination that the attribute mismatch does not exist within the range of street addresses, the tax code identifier check process.

24. The system of claim 18, wherein the validation process comprises at least one of an address validation process, a geographic validation process, and a spatial validation process.
